(19) United States
(12) Patent Application Publication
(10) Pub. No.: US 2005/0132585 A1
(43) Pub. Date: Jun. 23, 2005

(54) Flexible mirror attachment for electric shaver

(76) Inventors: Michael Weber, Brooklyn, NY (US); Allan S. Majeski, Brooklyn, NY (US)

Correspondence Address: Esther E. Schwartz, 1898 Ocean Avenue, Brooklyn, NY, 11230, US

(21) Appl. No.: 10/740,021

(22) Filed: Dec. 18, 2003

(51) Int. Cl. B26B 21/40

(52) U.S. Cl. 30/537

(57) ABSTRACT

A flexible mirror attachment that is permanently affixed to an electric shaver. A mirror is permanently affixed to one extreme of the flexible shaft, and the other extreme is permanently affixed to the electric shaver. In the preferred embodiment, the mirror is fog-free, and the flexible shaft is a gooseneck extension shaft, capable of being adjusted into complex curved shapes, and of retaining its shape after adjustment. It is attached to the lower back portion of the electric shaver so that it can be bent completely out of the way if desired.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) REFERENCE TO A “SEQUENCE LISTING,” A TABLE, OR A COMPUTER PROGRAM LISTING APPENDIX SUBMITTED ON A COMPACT DISC

Not Applicable

### (E) BACKGROUND OF THE INVENTION

(1) Field of the Invention

This invention relates to electric shaving devices. More particularly, this invention relates to electric shaving devices with a permanently affixed flexible mirror attachment.

(2) Description of the Related Art Including Information Disclosed under 37 CFR 1.97 and 1.98.

It has been recognized that it is beneficial to enhance one's view when shaving. Because a shaver inherently contains a blade, even when made to be safe, it poses a potential hazard to the person shaving. In addition, a person using a shaver undoubtedly prefers to get as close and as perfect a shave as possible. Many people employ varying techniques to increase the scope, area, and ease with which they can see the area they are shaving, using devices such as a mirror or a magnifying glass.

Yet, each of the current methods is not perfect. Using a mirror permanently affixed to the wall or other surface has many disadvantages. When the user has the leisure to stand in one place and the patience to lean and stretch his limbs this way and that, such a device is useful. However, in our fast-paced society, many people prefer not to be attached to one place.

Another device, the hand-held mirror, is useful for those who travel or simply wish to shave in different places at different times. There are many shaving devices that contain a separate mirror in the shaver case. Yet, despite portability, these devices present other problems. One is forced to either hold the mirror in addition to the shaver, which is quite cumbersome, or to prop up the small mirror somewhere to provide hands-free shaving.

Yet another device attempts to solve that problem by providing a clip-on mirror to be removably attached to a shaving device. That device provides hands-free shaving. However, it is still not a perfect solution. The clip on this clip-on mirror is either flush with both the shaver and mirror, or wedged at an angle. Therefore, this device, despite its hands-free benefits, still only provides for a limited viewing area.

A different device provides for a razor magnifying glass, to magnify the area being shaved, U.S. Pat. No. 6,476,984, Ringdahl, Nov. 5, 2002. The magnifying glass is attached to an extension shaft that could be manipulated to magnify from different angles. That is a very useful feature. However, in order to make use of the enlarged view one must bend to look directly through the glass.

In contrast, one benefit of a mirror is that it can be angled to view areas that are ordinarily out of sight. A magnifying glass merely magnifies an area already in sight.

It is therefore an object of the present invention to provide a mirror attachment on a completely flexible extension shaft to provide for ultimate viewing ability and hands-free ease for both a perfect shave, and a perfect shaving experience.

### (F) BRIEF SUMMARY OF THE INVENTION

We have invented a flexible mirror attachment for electric shavers. The apparatus is designed to be permanently attached to the electric shaving device. The apparatus contains a flexible shaft. A mirror is permanently affixed to one extreme of the flexible shaft, and the other extreme is permanently affixed to the electric shaver. In the preferred embodiment, the mirror is fog-free, and the flexible shaft is a gooseneck extension shaft, capable of being adjusted into complex curved shapes, and of retaining its shape after adjustment. It is attached to the lower back portion of the electric shaver so that it can be bent completely out of the way if desired. The flexible mirror attachment can be affixed to any portion of the shaver the user deems appropriate for varying preferred uses. The mirror can be of any shape or size to accommodate design and utility preferences. The flexible extension shaft can also be of any appropriate material, length, and thickness to provide the desired level of visibility without conflicting with shaving ease.

### (G) BRIEF DESCRIPTION OF THE SEVERAL VIEWS OF THE DRAWINGS

FIG. 1 depicts the flexible mirror attachment.

FIG. 2 is a front view of the preferred embodiment of the invention.

FIG. 3 is a rear view of the invention, depicting the site of attachment of the extension shaft and ability to flexibly move the shaft.

FIG. 4 is a front view of an alternate embodiment of the invention, showing a retractable flexible mirror attachment.

### (H) DETAILED DESCRIPTION OF THE INVENTION

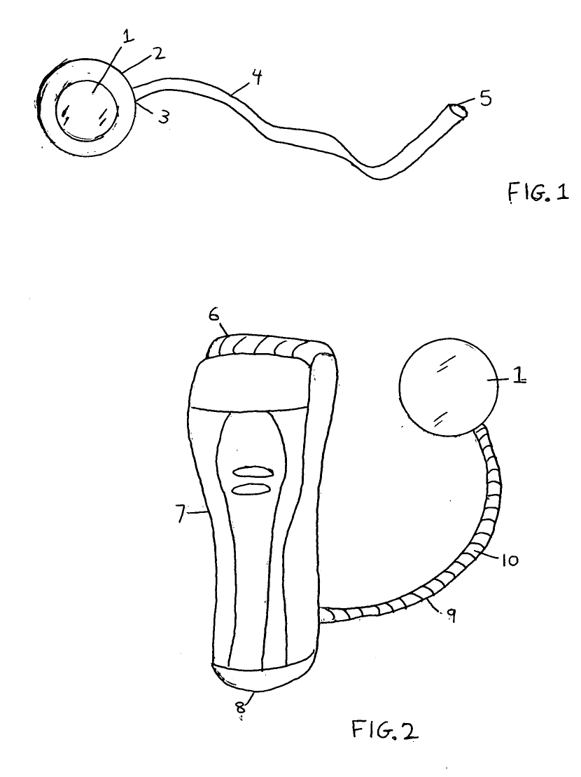

The invention, as depicted in FIGS. 1-4, generally comprises an electric shaving device, a flexible extension shaft permanently affixed to the shaving device, and a mirror permanently affixed to the extension shaft. The extension shaft can be affixed to any portion of the exterior or interior of the shaving device.

FIG. 1 portrays the flexible extension shaft and mirror, emphasizing the flexibility of the shaft. It contains a mirror 1 in a frame 2 attached to a first extreme 3 of a flexible shaft 4 capable of retaining its shape until further adjustment, and an opposite extreme 5 adapted to be permanently mounted to an electric shaving device. The flexible shaft 4 in FIG. 1 is of a solid, uniform, resilient and flexible material that can retain its shape until further adjustment.

FIG. 2 depicts the preferred embodiment, containing a mirror 1 and a gooseneck extension shaft 9 affixed to the lower back portion of the electric shaving device. The shaft should be affixed substantially closer to the bottom 8 of the device 7 than to the cutting edge 6 so as not to interfere with the user's holding or using the device. In this embodiment the flexible shaft can be manipulated to view every imaginable angle and bent backward and downward when not in use so as not to be in the way. The small circular mirror 1 is small enough to be unobtrusive but sufficient to adequately view the area intended. The gooseneck shaft 9 is made of a series of frictionally attached gooseneck annuli 10 to enable the shaft to be bent into complex shapes and retain the shape until bent again.

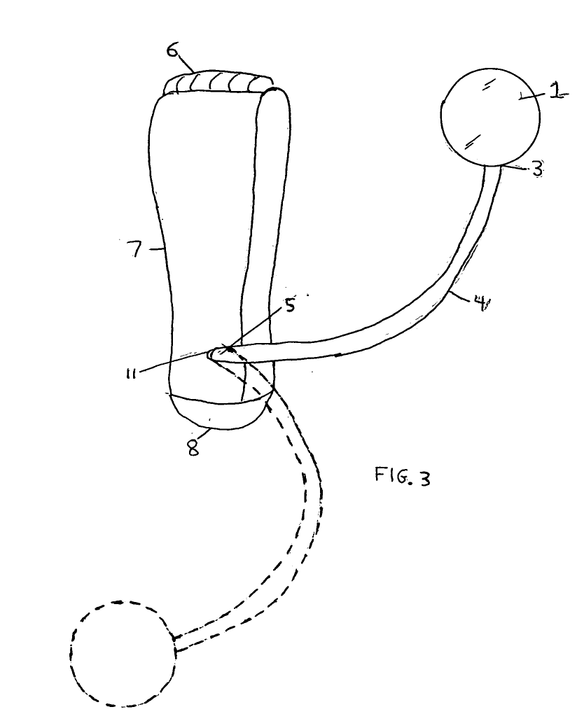

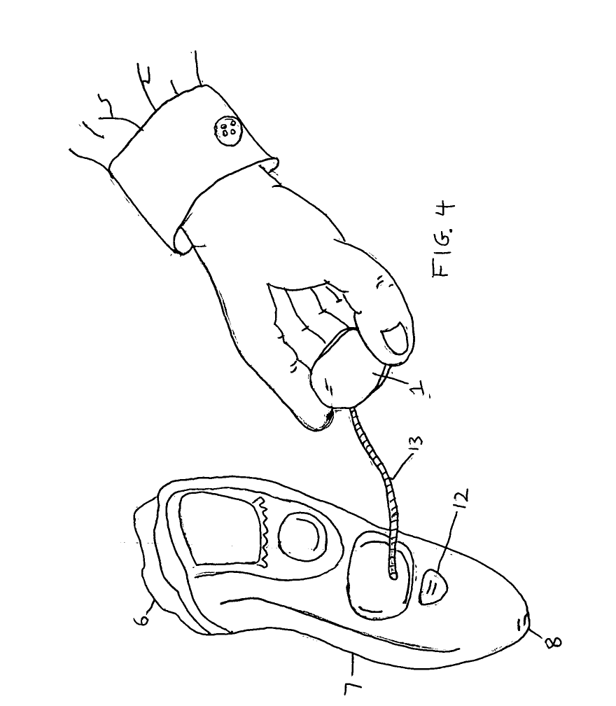

FIG. 3 represents a rear view of the entire invention. The second extreme 5 of extension shaft 4 is permanently affixed to site 11 on the shaving device 7. Extension shaft 4 with attached mirror 1 can be adjusted by being bent out of the way when not in use.

FIG. 4 represents an alternate embodiment of the invention containing a retractable flexible mirror attachment. Extension shaft 13 is made of material that does not have the ability to retain its shape when adjusted, such as a cord or a cable. Extension shaft 13 is retractable, with the major portion of the attachment stored within the shaving device. The shaving device is modified to receive the retracted portion when not in use. Release and return button 12 is used by the user to release and return the retracted portion as needed.

The mirror 1 can be of any desired size, shape, or material. The mirror can be made to be fog-free using means well known in the industry. The mirror can incorporate an enlarged view portion. The mirror can contain a normal view on one side and an enlarged view on the opposite side. The mirror can be frameless, with the extension shaft attached directly to the mirror. The mirror can be mounted in a frame, and the extension shaft mounted to the frame. The mirror 1 is attached to the first extreme 3 with a permanent fixative. The mirror can alternatively be set in a frame that is continuous with the flexible extension shaft, therefore not requiring any fixative at the first extreme.

The extension shaft 4 can be made of any appropriate material, length, and thickness to provide the desired level of visibility without conflicting with shaving ease. The material used can be flexible enough to form complex shapes and have the ability to retain its shape until readjusted by the user. Alternatively, the material used will not have the ability to retain its shape when adjusted, such as a cord or a cable. The shaft can be formed of one continuous uniform flexible piece, or of many sections attached frictionally or rigidly.

The shaft can be retractable, with the major portion of the attachment stored within the shaving device. The shaving device, in this embodiment, would be modified to receive the retracted portion when not in use. The entire attachment, including the mirror, can be retracted into the shaver, or only the extension shaft, leaving the mirror portion of the extension visible. A release and return button would be used to facilitate the retracting feature. The retracting shaft is manufactured using standard materials in the existing art. The shaft can also incorporate telescoping portions to provide increased length of the shaft without increased inconvenience to the user.

In addition, the structure can be further modified to contain a rotatable portion at either the first, second, or both extremes to provide even greater adjustment capabilities.

The flexible extension shaft with permanently attached mirror can be incorporated in the shaving device as manufactured or provided to the end user to be permanently affixed after purchase of the shaving device.

We have illustrated the preferred embodiments of the invention. However, it is to be understood that changes and variations may be made by those skilled in the art without departing from the spirit of the invention as claimed.

1. An Apparatus comprising:
a. an electric shaving device; and
b. a flexible extension arm with a first extreme thereof being permanently affixed to any portion of the exterior or interior of said electric shaving device; and
c. a mirror being permanently mounted to a second extreme of said flexible extension arm.

2. The apparatus of claim 1 where said flexible extension arm is capable of being flexibly adjusted in complex ways and retaining its shape until further adjusted.

3. The apparatus of claim 1 wherein said flexible extension arm is capable of being flexibly adjusted in complex ways but does not retain its shape when adjusted.

4. The apparatus of claim 1 where said flexible extension arm is resilient.

5. The apparatus of claim 1 wherein said flexible extension arm is waterproof.

6. The apparatus of claim 1 wherein said mirror is waterproof.

7. (canceled)

8. (canceled)

9. The apparatus of claim 1 wherein said flexible extension arm is retractable.

10. The apparatus of claim 1 wherein said flexible extension arm is retractable and said electric shaving device is modified to store said retractable flexible extension arm.

11. The apparatus of claim 1 wherein said flexible extension arm is retractable and said electric shaving device is modified to store said flexible extension shaft and attached mirror.

12. An apparatus comprising:
d. a flexible extension arm with the first extreme adapted to be permanently affixed to an electric shaving device; and
e. a mirror mounted to the second extreme of said flexible extension arm.

13. (canceled)

14. The apparatus of claim 12 wherein said mirror is framed.

15. An apparatus comprising:
a. a flexible extension arm with two opposite extremes;
b. a first extreme of said flexible extension arm adapted to be permanently affixed to an electric shaving device; and
c. a second extreme of said flexible extension arm adapted to receive a mirror.

16. The apparatus of claim 15 in which said flexible extension arm incorporates a frame adapted to receive a mirror.
